(19) United States
(12) Patent Application Publication
(10) Pub. No.: US 2007/0006205 A1
(43) Pub. Date: Jan. 4, 2007

(54) System for virtual image migration

(76) Inventors: Michael Kennedy, Round Rock, TX (US); Tim W. Cox, Austin, TX (US)

Correspondence Address: HAMILTON & TERRILE, LLP, P.O. BOX 203518, AUSTIN, TX, 78720, US

(21) Appl. No.: 11/132,015

(22) Filed: May 18, 2005

(51) Int. Cl. G06F 9/44

(52) U.S. Cl. 717/168; 717/174; 717/120

(57) ABSTRACT

A method for virtual image migration for configuring software of an information handling system platform which method defines a platform independent image on a medium readable by an information handling system determines a core operating system, enterprise configurations and a CAB file of drivers for each of plural platform model types with one or more installation functions operable to install the enterprise configurations in an operating system of an information handling system having one of the plural platform model types. The installation function determines the platform model type of an information handling system loaded with the platform independent image and configures the core operating system with the enterprise configurations and a driver file associated with the determined platform model type.

### BACKGROUND OF THE INVENTION

1. Field of the Invention

The present invention relates to information handling system configurations, and more particularly to a system for virtual image migration for configuring software of an information handling system platform.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The wide variety of hardware platforms and software configurations available for information handling systems provides business enterprises with great flexibility to purchase information handling systems adapted to handle desired functions. However, the use of varied hardware platforms and software configurations typically introduces complexity to the purchase and maintenance of information handling systems for an enterprise. For instance, a business enterprise often orders information handling systems over a time period resulting in the purchase of a variety of hardware platform configurations. Thus, a business enterprise often must attempt to maintain a uniform operating system and a set of uniform applications on different hardware platforms. As an example, a business enterprise typically maintains a predetermined version of WIDOWS and commonly-used enterprise applications for word processing and other functions, such as WORD and EXPLORER, on platforms with different processors, memory and peripherals, such as monitors and printers.

In order to configure information handling systems with consistent operating system and application loads for an enterprise customer, information handling system manufacturers typically load images with the desired configuration on a manufactured information handling system. An alternative to the use of an image is the use of an unattended installation, which loads a defined software configuration from an installation share point. In the event that difficulties arise after the information handling system is delivered, the business enterprise may re-install the software configuration by using the image or unattended installation used by the manufacturer.

One difficulty with maintaining a uniform software configuration for a business enterprise is that the image and unattended installation techniques for loading a software configuration lack the flexibility and reliability for re-installation across a wide variety of platforms of a business enterprise. Image installations are generally fast, simple and static, however, image installations generally require one image for each target platform and are inflexible in that any software configuration changes generally require the creation of a new image. In addition, transitions to new platforms usually require the creation of a new image with image management for multiple different platforms prone to expensive mistakes. Unattended installations are flexible and extendable in the support of multiple target platforms from a single installation share point, with new platforms added without effecting existing loads. New platforms are supported by unattended installations by adding new drivers and, if all target platforms need a similar change, a single modification to the installation share point will accommodate the change. However, unattended installations are generally difficult to create and modify and have a slow installation speed, often in excess of an hour, that typically precludes information handling system manufacturers from the use of unattended installations.

### SUMMARY OF THE INVENTION

Therefore a need has arisen for a virtual migration system which self-configures an information handling system independent of target platform hardware configuration. A further need exists for a system which installs a software configuration in: a flexible and rapid manner for use in information handling system manufacturing and in management of purchased information handling system software configurations.

In one embodiment, the invention relates to a method for generating an information handling system image. The method includes building a custom software image, loading the custom software image onto a virtual machine wherein the virtual machine is configured to operate as one of a plurality of physical information handling systems, executing the custom software image on the virtual machine to assure that the custom software image operates properly on the one of the plurality of physical information handling systems, and loading the custom software image on the one of the plurality of physical information handling systems.

In another embodiment, the invention relates to an apparatus for generating an information handling system image from a custom software image. The apparatus includes means for loading the custom software image onto a virtual machine wherein the virtual machine is configured to operate as one of a plurality of physical information handling systems, means for executing the custom software image on the virtual machine to assure that the custom software image operates properly on the one of the plurality of physical information handling systems, and means for loading the custom software image on the one of the plurality of physical information handling systems.

In another embodiment, the invention relates to a system for generating an information handling system image from a custom software image. The system includes a virtual machine configured to operate as one of a plurality of physical information handling systems, a loading module which loads the custom software image onto the virtual machine, an execution module which executes the custom software image on the virtual machine to assure that the custom software image operates properly on the one of the plurality of physical information handling systems, and an installation module which loads the custom software image on the one of the plurality of physical information handling systems.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of a system for providing virtual image migration.

FIG. 2 shows a block diagram of a system for creating and deploying a platform independent image;

FIG. 3 shows a flow diagram for creating and deploying a platform independent image;

FIG. 4 shows a flow diagram for creating a platform independent image; and

FIG. 5 shows a flow diagram for configuring an information handling system with a platform independent image.

FIG. 6 shows a block diagram of an information handling system having an image loaded based upon a virtual image.

### DETAILED DESCRIPTION

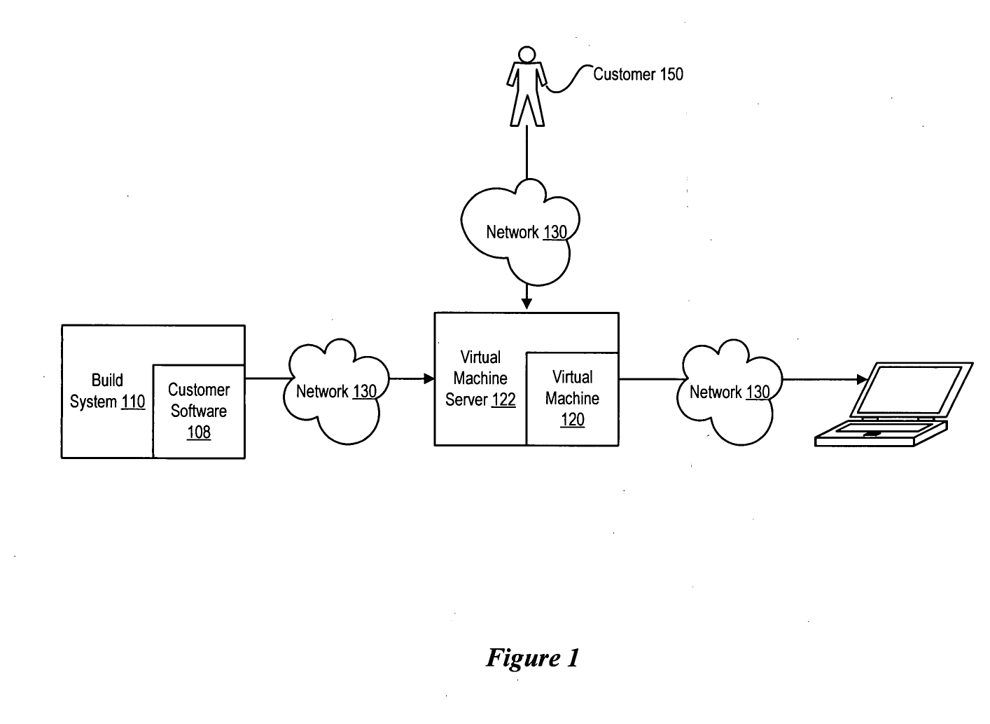

Referring to FIG. 1, a system 100 for virtual image migration is shown. The system 100 generates or modifies a custom software load 108 (e.g., a custom operating system load) via a build system 110. The system 100 then moves the custom software load 108 to a virtual machine 120 (i.e., a software instantiation of a particular information handling system) which is executing on a virtual machine server 122. The virtual machine 120 may then be accessed via a network 130 (e.g., a http or similar web access) for test and/or modification of the software load 108 executing on the virtual machine 120. The system 100 also includes a process for modifying the software load 108 of the virtual machine 120 to facilitate the testing and modification of software 108 for operation on a target system 140 (e.g., a new physical information handing system). The target system 140 may be the same or different from the build system 110.

The resulting operating system load retains no trace of having been modified using the virtual machine 120. Thus, the system 100 allows customers 150 to create images on one system (i.e., the virtual machine 120) and then migrate the images to many different target systems 140. Loading the software on the virtual system 120 also enables the customer 150 to test the software image 108 from a remote location.

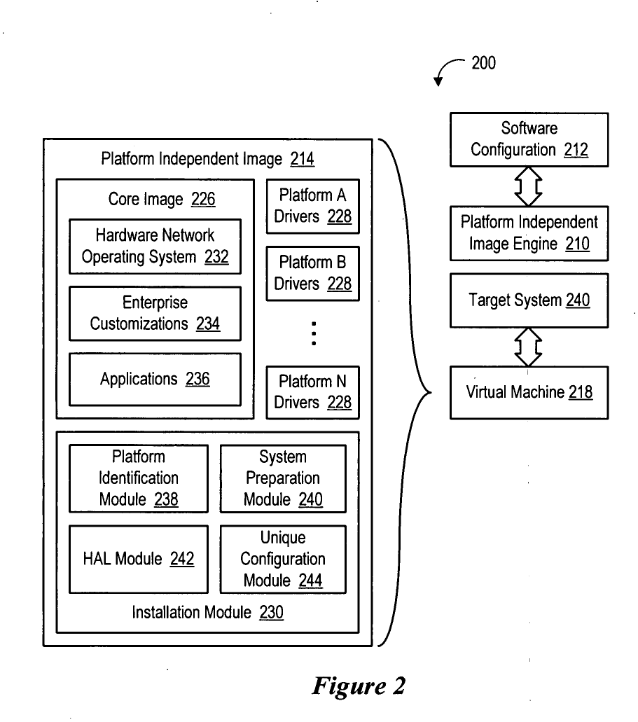

Referring to FIG. 2, software that is loaded onto the virtual machine 120 may be developed using a system 200 for creating and deploying a platform independent image. A platform independent image engine 210 analyzes a software configuration 212 and generates a platform independent image 214. The platform independent image 214 is copied to the virtual machine 120. The virtual machine 120 is configured to represent one of a set of defined hardware platforms identified by a platform model type (i.e., the represent a target system 140). The platform independent image 214 identifies the platform model type and configures the virtual system 120 with drivers associated with the model type as well as with non-model type drivers associated with other hardware of the target system 120, such as post-purchase hardware installations and peripheral devices like a monitor and a printer.

In one embodiment, the platform independent image 214 has a modular architecture with a core image 226 that defines a software configuration for an enterprise, a set of platform drivers 228 that provide drivers for associated platform model types and an installation module 230 that provides intelligence for the self-configuration of an information handling system having the image. Core image 226 includes a hardware neutral operating system 232, enterprise customizations 234 and enterprise applications 236 that define the software configuration for an enterprise. For instance, platform independent image engine 210 analyzes an information handling system configured as desired by an enterprise, and creates core image 226 by identifying, saving and removing configuration uniqueness as enterprise customizations 234, saving a driverless operating system as hardware neutral operating system 232, and saving enterprise-common applications 236 such as word processing, anti-virus, browser and other commonly deployed applications. Each platform driver file 228 includes drivers deployed to an associated platform model type so that platform independent image 214 is easily adapted to support new platforms by adding a cabinet (CAB) file of drivers 228 for each new platform. Installation module 230 includes a platform identification module 238 that determines the platform model type of an information handling system having platform independent image 214, provides the associated driver file 28 for system preparation module 240 to configure the operating system, and removes the remaining platform driver files 228. A Hardware Abstraction Layer (HAL) module 242 determines if a Hardware Abstraction Layer exists and establishes updated settings for the Hardware Abstraction Layer. A unique configuration module 244 applies the enterprise customizations 234 to the operating system and applications to complete installation of the enterprise configuration on a target platform.

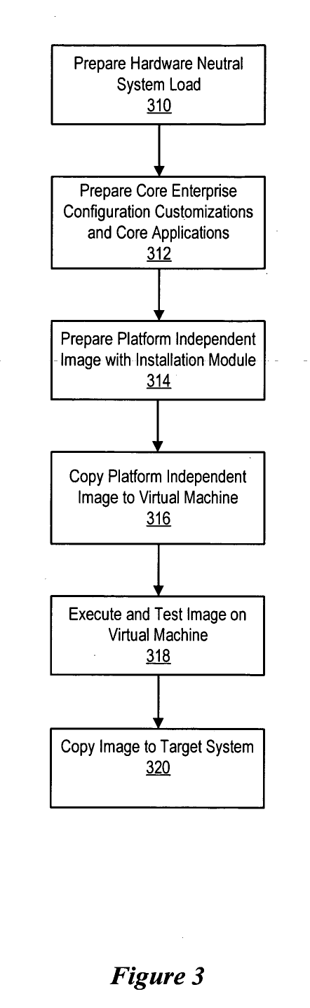

Referring now to FIG. 3, a flow diagram depicts a process for creating and deploying a platform independent image. At step 310, a core image hardware neutral operating system load is prepared from an information handling system configured with the desired enterprise software configuration (e.g., the build system 110). For instance, a desired version of WINDOWS deployed by the enterprise is copied without drivers for platform and non-platform model type hardware. At step 312, the core image enterprise configuration customizations and applications are prepared from the enterprise-configured information handling system. The configuration uniqueness of the enterprise software configuration are identified and saved for re-application. At step 314, the platform independent image is prepared with the core image operating system, enterprise configuration customizations and applications, the platform model type drivers and the installation module to provide installation intelligence. At step 316, the platform independent image is copied to the virtual machine 120. At step 318, the image is executed and tested on the virtual machine to assure a correct installation of the enterprise software configuration. At step 320, the image is copied to the target system 140 and the target information handling system is booted to initiate installation of the software configuration with the installation module as well as the appropriate hardware abstraction layer (HAL) and drivers. The platform independent image 214 may be copied to a newly manufactured information handling system for initial installation of the enterprise software configuration or may be copied to a deployed enterprise information handling system to reinstall or update the enterprise software configuration. Updates to the enterprise software configuration are managed by updating an appropriate module, such as adding a new platform driver file, adding a new or modified enterprise customization or application.

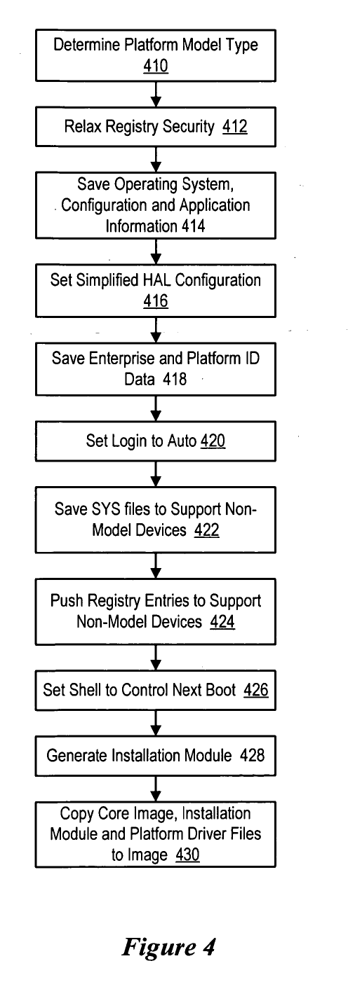

Referring now to FIG. 4, a flow diagram of a process for creating a platform independent image from an information handling system having the enterprise software configuration (e.g., a build system 110) is shown. The process starts at step 410 with a determination of the platform model type on which the enterprise software configuration is loaded. At step 412, the registry security is relaxed for the information handling system to allow access to the registry settings and analysis of the enterprise software configuration for the determined platform model type. At step 414, the operating system is saved without driver registry settings and the configuration uniqueness and applications for the enterprise configuration are identified and saved.

Starting at step 416, the functions of installation module 230 are defined. At step 416, if a Hardware Abstraction Layer (“HAL”) exists for high performance and/or multiprocessor usage, the existing Hardware Abstraction Layer settings are simplified to a lowest common denominator setting to ensure backwards compatibility for all existing platform model types that include Hardware Abstraction Layer functionality. At step 418, enterprise and platform identification data are saved, such as user-required variables like machine naming and domain joining. At step 420, the operating system login setting is set to auto for initiating boot at power-up of an information handling system having the platform independent image. At step 422, the SYS files for supporting non-platform model type devices, such as third party hardware and peripheral devices, are saved and, at step 424 the registry entries for supporting the non-platform model type devices are pushed to the enterprise customizations. At step 426, the Shell is set to control the next boot of an information handling system having the platform independent image and, at step 428 the installation module is generated. At step 430, the core image, platform drivers for all applicable platform model types and the installation module are copied to form the platform independent image.

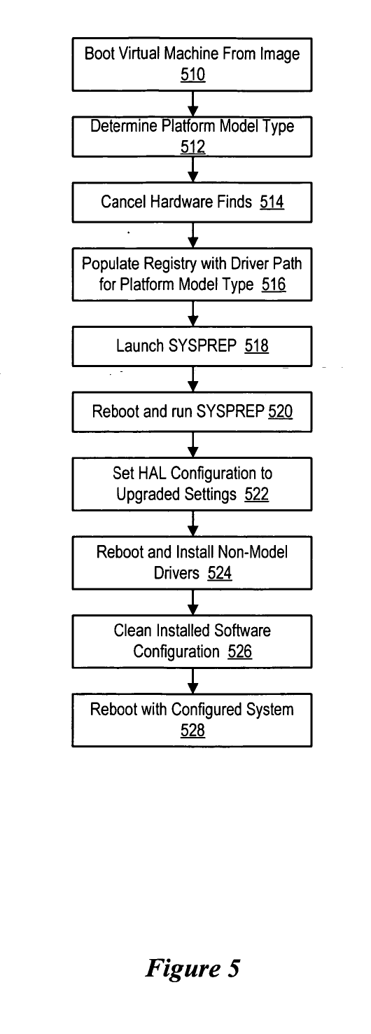

Referring to FIG. 5, a flow diagram of a process for configuring a virtual machine 120 with a platform independent image copied to the virtual machine 120 is shown. At step 510, the virtual machine 120 is booted from the image. At step 512, the installation module determines the platform model type for which the virtual machine 120 is configured. At step 514, the installation module cancels automatic hardware find functions of the operating system, such as plug-and-play functions. At step 516, the installation module populates the operating system registry of the virtual machine 120 with the driver path for the driver file associated with the determined platform model type. At step 518, the installation module launches a system preparation function, such as the SYSPREP function of the WINDOWS operating system, to initiate installation of the drivers. At step 520, the virtual machine 120 is rebooted to run the system preparation function for loading the drivers associated with the determined platform model type into the virtual machine operating system. At step 522, the Hardware Abstraction Layer settings are detected and upgraded to settings appropriate for the enterprise software configuration. At step 524, the virtual machine is re-booted and non-platform model drivers are installed to support hardware configurations of third party or peripheral devices added to the information handling system platform by the enterprise. At step 526, the installed software configuration is cleaned, such as by deleting unused platform driver files, and at step 528 the information handling system is re-booted to have the enterprise software configuration installation completed and operational.

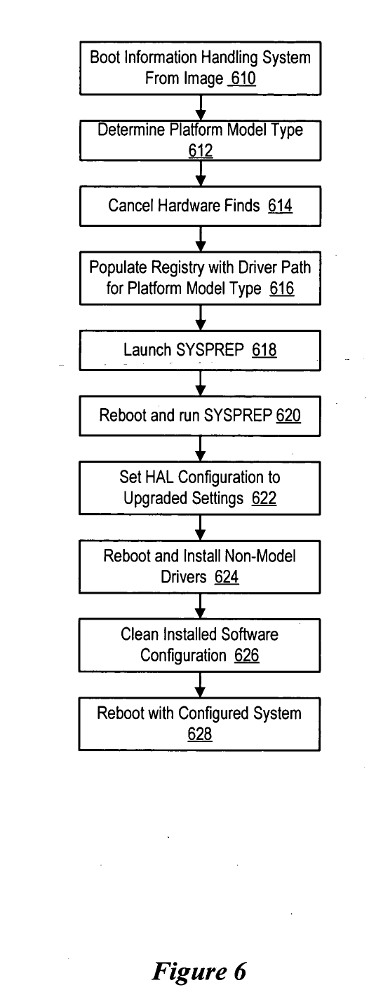

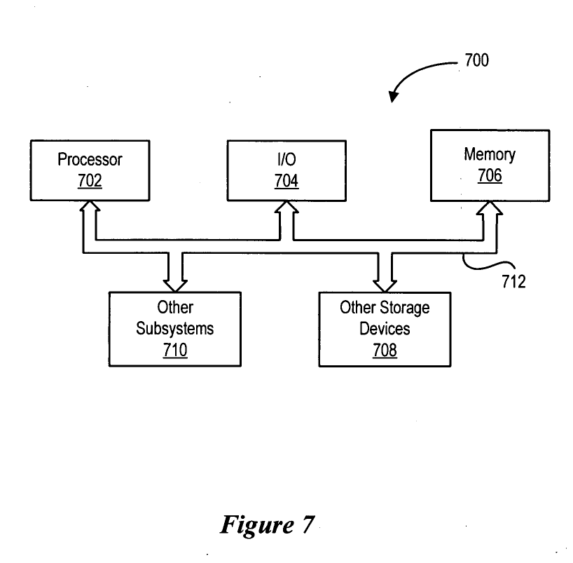

Referring to FIG. 6, a flow diagram of a process for configuring an information handling system with a platform independent image that was installed and tested on the virtual machine 120 is shown. At step 610, the virtual machine 120 is booted from the image. At step 614, the installation module cancels automatic hardware find functions of the operating system, such as plug-and-play functions. At step 616, the installation module populates the operating system registry of the information handling system with the driver path for the driver file associated with the determined platform model type. At step 618, the installation module launches a system preparation function, such as the SYSPREP function of the WINDOWS operating system, to initiate installation of the drivers. At step 620, the information handling system is rebooted to run the system preparation function for loading the drivers associated with the determined platform model type into the virtual machine operating system. At step 622, the Hardware Abstraction Layer settings are upgraded to settings appropriate for the enterprise software configuration. At step 624, the information handling system is re-booted and non-platform model drivers are installed to support hardware configurations of third party or peripheral devices added to the information handling system platform by the enterprise. At step 626, the installed software configuration is cleaned, such as by deleting unused platform driver files, and at step 628 the information handling system is re-booted to have the enterprise software configuration installation completed and operational.

The platform independent image simplifies the scripting of operating system and driver settings for an enterprise by allowing the configuration of a new or existing information handling system with enterprise software from a single share point installation regardless of the hardware configuration of the target platform. The target software configuration is performed in a rapid manner from an image transferred to the information handling system and works on any platform having a CAB file of drivers defined in the image (there are a plurality of CAB files, each of which correspond to a particular system). In addition to rapid installation from a single image, the platform independent image also offers ease of management through a modular design that updates an enterprise software configuration by updating the module associated with changes to the enterprise software configuration. An enterprise manages a consistent software configuration across different types of platforms and more easily coordinates with information handling system manufacturers for ordering new information handling systems with the desired software configuration, even as new platform model types are designed and produced.

Referring briefly to FIG. 7, a system block diagram of an information handling system 150 is shown having software loaded in accordance with the system for virtual image migration as discussed herein. The information handling system 150 includes a processor 702, input/output (I/O) devices 704, such as a display, a keyboard, a mouse, and associated controllers, non-volatile memory such as a hard disk drive 706, and other storage devices 708, such as a floppy disk and drive and other memory devices, and various other subsystems 710, all interconnected-via one or more buses, shown collectively as bus 712.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used-for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for generating an information handling system image, the method comprising:
building a custom software image;
loading the custom software image onto a virtual machine, the virtual machine being configured to operate as one of a plurality of physical information handling systems;
executing the custom software image on the virtual machine to assure that the custom software image operates properly on the one of the plurality of physical information handling systems; and,
loading the custom software image on the one of the plurality of physical information handling systems.

2. The method of claim 1 further comprising:
modifying the custom software image while the custom software image is executing on the virtual machine.

3. The method of claim 3 further comprising:
testing the modified custom software image while the custom software image is executing on the virtual machine.

4. The method of claim 1 further comprising:
configuring the virtual machine to represent another of the plurality of physical information handling systems; and, modifying the custom software image while the custom software image is executing on the virtual machine to conform to the another of the plurality of physical information handling systems.

5. The method of claim 4 further comprising:
testing the modified custom software image while the custom software image is executing on the virtual machine.

6. The method of claim 1 wherein:
the building a custom software image includes starting with a predefined software image; and, modifying the predefined software image to correspond to a particular customer custom software image.

7. An apparatus for generating an information handling system image from a custom software image, the apparatus comprising:
means for loading the custom software image onto a virtual machine, the virtual machine being configured to operate as one of a plurality of physical information handling systems;
means for executing the custom software image on the virtual machine to assure that the custom software image operates properly on the one of the plurality of physical information handling systems; and,
means for loading the custom software image on the one of the plurality of physical information handling systems.

8. The apparatus of claim 7 further comprising:
means for modifying the custom software image while the custom software image is executing on the virtual machine.

9. The apparatus of claim 8 further comprising:
means for testing the modified custom software image while the custom software image is executing on the virtual machine.

10. The apparatus of claim 7 further comprising:
means for configuring the virtual machine to represent another of the plurality of physical information handling systems; and,
means for modifying the custom software image while the custom software image is executing on the virtual machine to conform to the another of the plurality of physical information handling systems.

11. The apparatus of claim 10 further comprising:
means for testing the modified custom software image while the custom software image is executing on the virtual machine.

12. The apparatus of claim 7 wherein:
the custom software image includes a predefined software image that is modified to correspond to a particular customer custom software image.

13. A system for generating an information handling system image from a custom software image, the system comprising:
a virtual machine configured to operate as one of a plurality of physical information handling systems;
a loading module, the loading module loading the custom software image onto the virtual machine;
a execution module, the execution module executing the custom software image on the virtual machine to assure that the custom software image operates properly on the one of the plurality of physical information handling systems; and,
an installation module, the installation module loading the custom software image on the one of the plurality of physical information handling systems.

14. The system of claim 13 further comprising:
a modification module, the modification module modifying the custom software image while the custom software image is executing on the virtual machine.

15. The system of claim 14 further comprising:
a testing module, the testing module testing the modified custom software image while the custom software image is executing on the virtual machine.

16. The system of claim 13 further comprising:
a configuring module, the configuring module configuring the virtual machine to represent another of the plurality of physical information handling systems; and,
a modification module, the modification module modifying the custom software image while the custom software image is executing on the virtual machine to conform to the another of the plurality of physical information handling systems.

17. The system of claim 16 further comprising:
a testing module, the testing module testing the modified custom software image while the custom software image is executing on the virtual machine.

18. The system of claim 13 wherein:
the custom software image includes a predefined software image that is modified to correspond to a particular customer custom software image.
